(19) United States
(12) Patent Application Publication
(10) Pub. No.: US 2004/0224624 A1
(43) Pub. Date: Nov. 11, 2004

(54) Token dispensing apparatus

(76) Inventor: Akito Terazawa, Tokyo (JP)

Correspondence Address: MCGLEW & TUTTLE, PC, 1 SCARBOROUGH STATION PLAZA, SCARBOROUGH, NY, 10510-0827, US

(21) Appl. No.: 10/832,064

(22) Filed: Apr. 26, 2004

(30) Foreign Application Priority Data
May 6, 2003 (JP) JP 2003-128389

(51) Int. Cl. G07D 1/06; G07D 3/00; G07F 7/00

(52) U.S. Cl. 453/2

(57) ABSTRACT

A container for storing the tokens is dispensed automatically and is kept at a predetermined position. The customer does not get injured from the apparatus container guiding features using holders each having an arcuate and continuous surface. The apparatus for guiding and holding and automatically dispensing the container is small. The token dispensing apparatus has a container providing unit which provides a container to a dispensing section one by one based on a dispensing signal. The container is a bucket like in shape and stores tokens. A token dispensing unit dispenses the tokens to the provided container at the dispensing section. A pair of holders are located across the container and go towards each other. The holders include a holding surface which has the arc and can have contact with the container.

### CROSS REFERENCE TO RELATED APPLICATIONS

This application claims the benefit of priority under 35 U.S.C. § 119 of Japanese Application No 2003-128389 filed May 6, 2003 the entire contents of which are incorporated herein by reference.

### FIELD OF THE INVENTION

This invention is related to a token dispensing apparatus which dispenses tokens corresponding to money received in the dispenser from a user. Particularly, this invention relates to a token dispensing apparatus which dispenses tokens (e.g., tokens or coins) to a container. In this specification, “token” is generally a medium for amusement, but shall be understood to also include discs such as for example coins (coin currency), gaming medals gamming tokens etc. In this context, the coin, token or medal is dispensed by the dispensing apparatus for use in gaming or in an arcade game.

### BACKGROUND OF THE INVENTION

A token dispensing apparatus is known where a container for tokens is provided automatically to a dispensing section, and predetermined tokens correspond to the received money is dispensed to the container (for example Japanese Patent No. 2860818 (page 2, FIGS. 1 and 2) No. 1). Also, a container for drinks is guided to a predetermined position by a pair of chutes which are drainpipe like in shape in a vending machine for dispensing a drink in the container (for example Japanese Patent Publication of examined application No. 58-46755 (pages 2 and 3, FIGS. 1 and 2).

The container for storing tokens automatically falls down to the dispensing section in the device of Japanese Patent No. 2860818. In this case, the last position of the container is the position it lands after being dispersed. Because the container jumps in various directions as a reaction to the dispensing, the tokens are not always dispensed into the container.

Japanese Patent Publication of examined application No. 58-46755 discloses a guide structured by chutes and wherein it is tapered downwards. Therefore the container is guided to a predetermined position. The container receives a selected drink, afterwards a purchaser receives the container. In this process, the chutes are moved by the upper section of the container. The chutes are made of stainless steel plate for sanitation.

The chute which is disclosed in Japanese Patent Publication of examined application No.58-46755 could in theory be used with a token dispensing machine of Japanese Patent No.2860818 for guiding the container. However, if the tokens overflow from the container but are still located at the inner part of the container, the tokens must be taken out by hand and put into the space between the chute and the wall of the dispensing section. The customer or user is in danger of an injury, because the users hand is pressed to the edge of the chute which is sometimes sharp.

Also, the token dispensing machine only needs or must only take up a small space. Such a machine is only to be an auxiliary feature in an arcade for amusements or in a gamming location. When the container is provided to be dispensed automatically to the dispensing section, the storage room for the containers it is desirable for the space to be larger for reducing the manual work load. Therefore the route for guiding the container should be shorter and made to function quicker and easier.

However, the chute is too long in the prior art of the Japanese Patent Publication of examined application No.58-46755. As a result, the height of the token dispensing machine becomes higher to an unacceptable level.

### SUMMARY OF THE INVENTION

The primary object of this present invention is to provide a container for storing the tokens which is dispensed automatically and is provided and kept at a predetermined position.

Another object of this invention is to provide a customer with a container and token dispenser which avoids potential injury situations from the apparatus which guides and maintains or supports the container.

Another object of this invention is to provide an apparatus for guiding and keeping the container which is automatically dispensed and which is dimensionally smaller.

According to the invention, these objects are attained with a structure that includes a container providing unit which provides a container to a dispensing section one by one based on a dispensing signal. The container is bucket like in shape and is of a size to receive and store tokens. A token dispensing unit is provided which dispenses the tokens to the provided container at the dispensing section. A pair of holders are located across the container (extend into dispensing section) and go towards each other. The holders include holding surfaces which is an arc and can have contact (provide a contact support surface) with the container.

In this structure, the lowest container in piled up or staked into other containers. The lowermost containers falls based on the action of the container providing unit. The fallen container goes between the support surfaces or guiding surfaces of a pair of holders. These support surfaces are each an arc. The arc surfaces of the container contact with the support surfaces before the container goes on to the bottom of the dispensing section. The holders move back resiliently, as a result, they absorb the falling energy. In other words, falling shock of the container onto the bottom of the dispensing section is reduced.

Also, when the container in its falling state gets out of line form the desired position line, the container is moved to a predetermined position, because the container is held or guided by the support surfaces at both sides. In other words, the holders are movable resiliently and are restored to the predetermined desired position. Therefore the container is moved to the balance position by the restoring forces. As a result, the container is moved to approximately the restoring position. As a result, the dispensing tokens can properly be fed in and stored into the container.

This present invention is desirable, because the holder includes reforming sections which are located at the ends of the holding surfaces, and guiding surfaces which are extended outwards and upwards from the reforming sections and the holding surface. In this structure, when the container falls in or slants towards the dispensing slot, the reforming sections have contact with the side wall of the container. The contacted container pivots at a contacting point, and falls. Therefore the container moves opposite to the reforming section. Afterwards, the container becomes approximately level at the support section which encloses the concave sections of holders. Also, when the container falls in or slants towards the left or right, the corner between the bottom and the side wall is guided by the guiding surface which extends outwards and upwards.

Therefore the container becomes approximately level at the supporting section. As a result, despite the slant or shift the container is moved to a predetermined position. Also, the holders are made by a face each other at the reforming section and at the guiding surface. Accordingly, the customer does not receive any injury from the apparatus which is supporting or reforming and keeping the container.

The present invention is desirable, because the dispensing section is a box and includes a taking out opening which is located at a side wall and three side walls, holder openings which are located at the side walls which continues to the taking out or removal opening, and the holders protrude from the openings. In this structure, the dispensing section is box shaped and the holders protrude into the dispensing section from the openings which are located at left and right walls. Therefore the design avoids any situation in which the customer may be injured, because the end section is not located at the dispensing section.

The present invention is further desirable in providing in combination a container detecting unit which detects the container at the dispensing section, a dispensing controlling unit which starts the token dispensing unit based on a container detecting signal from the detecting unit, a counting unit which counts the dispensing tokens from the dispensing unit, a stopping unit which outputs a stopping signal for the dispensing unit when the counter counts a predetermined number.

In this structure, a container is provided or fed automatically to a predetermined position. The provided container is detected by the container detecting unit and outputs a dispensing signal. The token dispensing unit starts based on the detecting signal, and the tokens are dispensed into the container. When the dispensed tokens reach a predetermined amount, the counter outputs a stopping signal. The token dispensing unit stops based on the stopping signal, and the token dispensing operation finishes. Therefore the operation is convenient for the customer, because it is automatic.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a schematic view of an embodiment of a token dispensing apparatus according to the invention;

FIG. 2 is a perspective view of the container providing unit which is used in the embodiment of FIG. 1 of the token dispensing apparatus according to the invention;

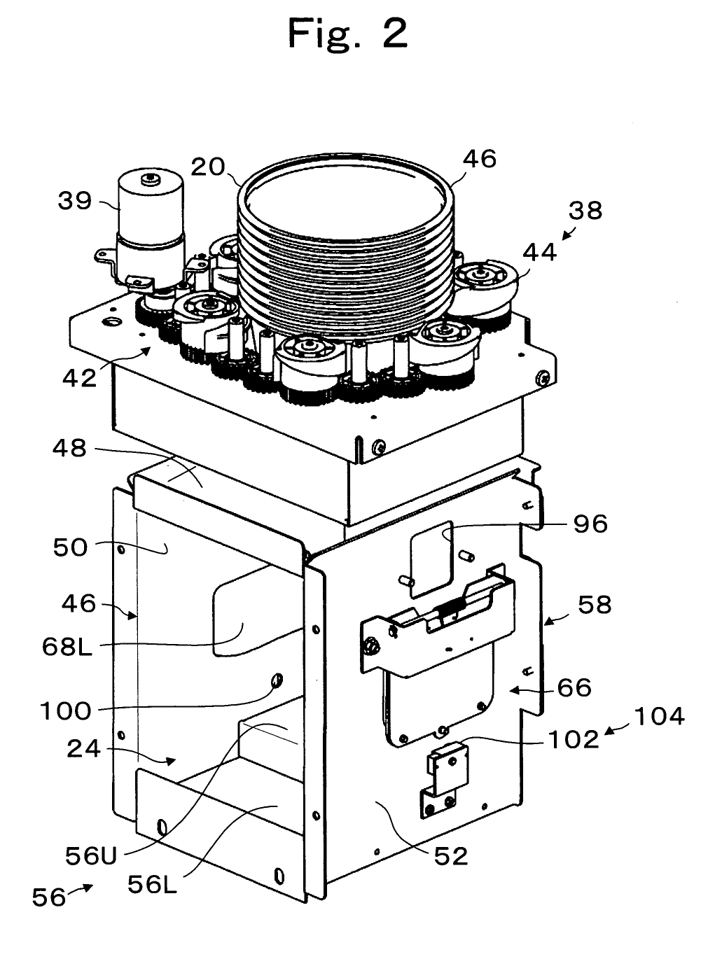

FIG. 3 is a perspective view of the container holder of the embodiment of FIG. 1 of the token dispensing apparatus according to the invention;

FIG. 4 is a plane view of the container holder of the embodiment of FIG. 1 of the token dispensing apparatus according to the invention;

FIG. 5 is a front view of the container holder in standby situation of the embodiment of FIG. 1 of the token dispensing apparatus according to the invention;

FIG. 6 is a front view of the container holder in holding situation of the embodiment of FIG. 1 of the token dispensing apparatus according to the invention;

FIG. 7 is a controlling block diagram of the embodiment of FIG. 1 of the token dispensing apparatus according to the invention; and

FIG. 8 is a flow chart for explaining the operation of the embodiment of FIG. 1 of the token dispensing apparatus according to the invention.

### DESCRIPTION OF THE PREFERRED EMBODIMENT

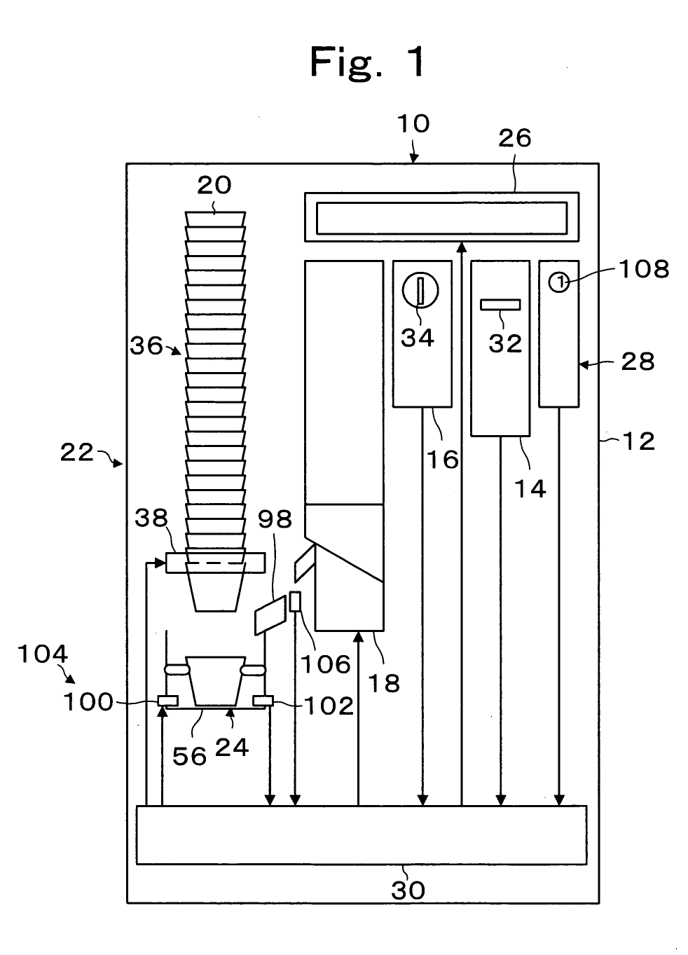

In FIG. 1, shows a token (i.e., tokens, coins, medals, etc.) dispensing apparatus 10 that includes a banknote distinguishing receiving unit 14, a coin distinguishing receiving unit 16, a token dispensing unit 18, a container providing unit 22 for storing containers 20, a dispensing section 24 for the container 20 and the token dispensing section 24. The token dispensing apparatus 10 also has a display 26, operating board 28 and controlling unit 30 in case 12.

The banknote distinguishing receiving unit 14 distinguishes a banknote which is inserted into receiving slot 32 to either see if the banknote (e.g., dollar bill, five dollar bill etc.) is genuine or not. When the banknote is fake, it is returned, also when the banknote is genuine, the domination is distinguished and is outputted to controlling unit 30, afterwards it is stored into a storing section (not shown).

Coin distinguishing receiving unit 16 distinguishes coins which are inserted into the receiving slot 34 to either see if such coin is genuine or not. When the coin is fake, it is returned, also when the coin is genuine, the domination is distinguished and is output to controlling unit 30, afterwards it is stored into a storing section (not shown).

The money receiving unit can be changed to a reading and writing unit for a magnetic card or a smart card or this may be provided in addition. Also, as above-mentioned distinguishing units and the reading and writing unit can be combined suitably.

The token dispensing unit 18 has a function where tokens are dispensed one by one based on a dispensing signal. The token dispensing unit 18 is a coin hopper; for example Japanese utility model registration number 2538531 which is hereby incorporated by reference. The coin hopper is desirable, because it has a counter for counting the dispensed tokens. Also, plural coin hoppers can be provided such that the dispensing of the tokens may be made more quickly.

The container providing unit 22 has a function which automatically provides storing containers 20 one by one to dispensing section 24 based on a providing signal. Storing container 20 is a bucket and stores some tokens. Container providing unit 22 includes container storing section 36 for storing piled up or stacked containers 20 and separating section 38 for separating the lowest container 20 and falling to dispensing section 24. Separating section 38 includes plural cams 38 which are rotated by motor 39 through gear 42. The cams 38 include an upper surface which supports the reverse of the flange 46 of container 20 and a cam which is a helix and pushes flange 46 of the lowest container 20. Therefore the lowest container 20 which is kept by a friction between the inner surface of the lowest container and the outer surface of the second lower container is dropped .

Container 20 which is provided by container providing unit 22 is kept at a predetermined position in dispensing section 24, afterwards predetermined tokens are dispensed into the container 20. Dispensing section 24 includes front opening 46 which is a removal opening and upper opening 48. In other words, dispensing section 24 is enclosed by left side wall 50, right side wall 52, rear side wall 54 and bottom wall 56 and is box 58. Upper opening 48 is located under separating section 38. Front opening 46 is located at the front surface of token dispensing machine 10.

The bottom 56 includes lower bottom 56L which is located near the front opening 46 and upper bottom 56U which is located at rear side wall 54. The lower bottom 56L is lower than the upper bottom 56U based on the stair or step portion. Therefore a space is located between the bottom of container 20 and lower bottom 56L. A finger can fit into the space. Therefore when the container 46 is taken out, the user's or customer's first finger hooks to flange 46 and other fingers are hooked to the bottom of container 20.

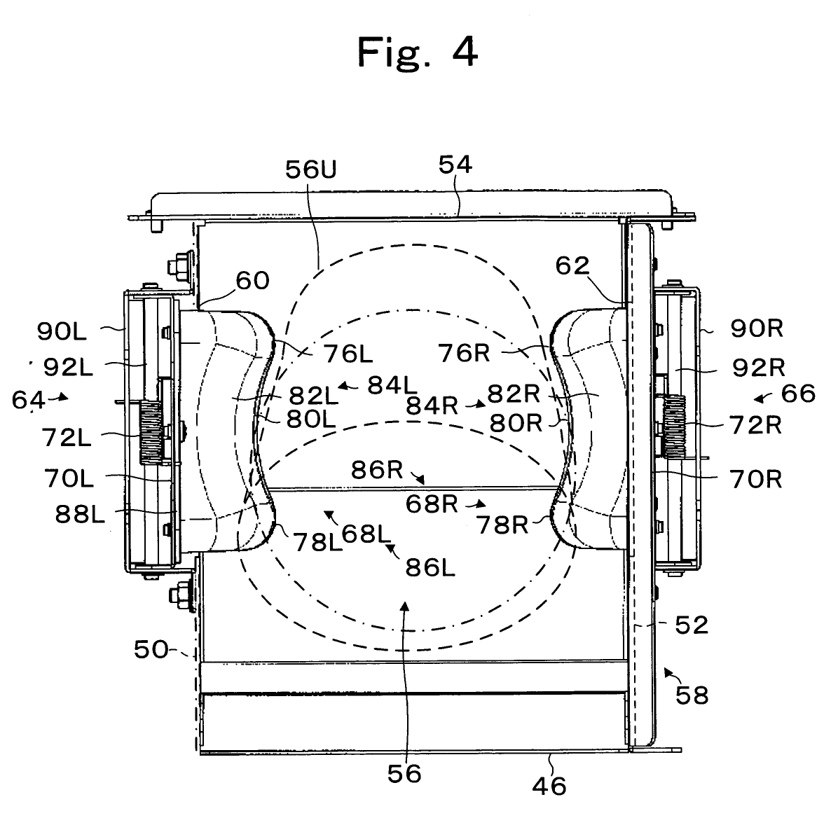

As shown in FIG. 4, left holder opening 60 and right holder opening 62 are opened at the middle at the up and down direction and slightly backwards in the front and rear at left side walls 50 and 52. Left holder unit 64 and right holding unit 66 are located corresponding to the left holding opening 60 and right holder opening 62. Left holder unit 64 and right holding unit 66 are structured symmetrically. Left holder unit 64 is explained for convenience. The corresponding parts of right holding unit 64 are attached with the same number with “R”.

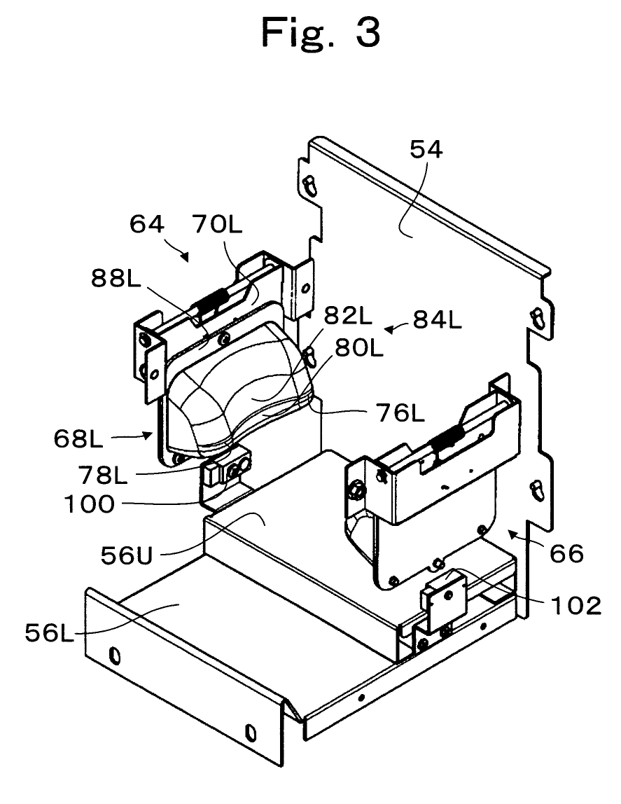

Left holding unit 64 includes holder 68L, base 70L, urging unit 72L and position adjusting unit 74L. As shown in FIG. 4, holder 68L includes reforming sections (or reorienting/righting sections) 76L,78L, holding surface 80L and guiding surface 82L, and they are connected smoothly (to form a continuous surface) by curved surfaces which extend up and in the down direction shown in FIG. 3. Reforming sections 76L and 78L are located at a predetermined distance at the side. Holding surface 80L connects between the reforming sections 76L and 78L in an arc which expands outwards, and is concave. Guiding surface 82L extends upwards and outwards from reforming section 76L, holding surface 80L and reforming section 78L. In other words, holder 68L includes concave section 84L which extend upwards as shown in FIG. 3. Also, the upwards and outwards directions are disposed relatively in a position for the middle section of box 58 of dispensing section 24.

The holder 68L is made from a resin in unifying structure. The distance between reforming sections 76L and 78L is approximately one sixth of the round length (the perimeter) of container 20 for establishing the position of container 20. In this situation, container 20 can be taken off easily from the holders, because container 20 is slightly enclosed by reforming sections 76L and 78L, and the moving distance of holders 68L, 68R are shorter. Therefore the resistance to taking out or removing the container is smaller based on urging units 72L, 72R. Flange 88L which is around protruding section 86L is fixed at base 70L. The flange 88L is rectangle and extends perpendicular.

Base 70L is larger than left holding opening 60, and the upper section is pivotable on shaft 92L which is level and is fixed at bracket 90L of left side wall 50. Also, base 70L is urged to dispensing section 24 as protruding by urging unit 72L where a spring is rounded on shaft 92L. Next position adjusting unit 74L is explained. Adjusting screw 94L is screwed at the lower middle section of base 70L, and is locked by lock nut 96L.

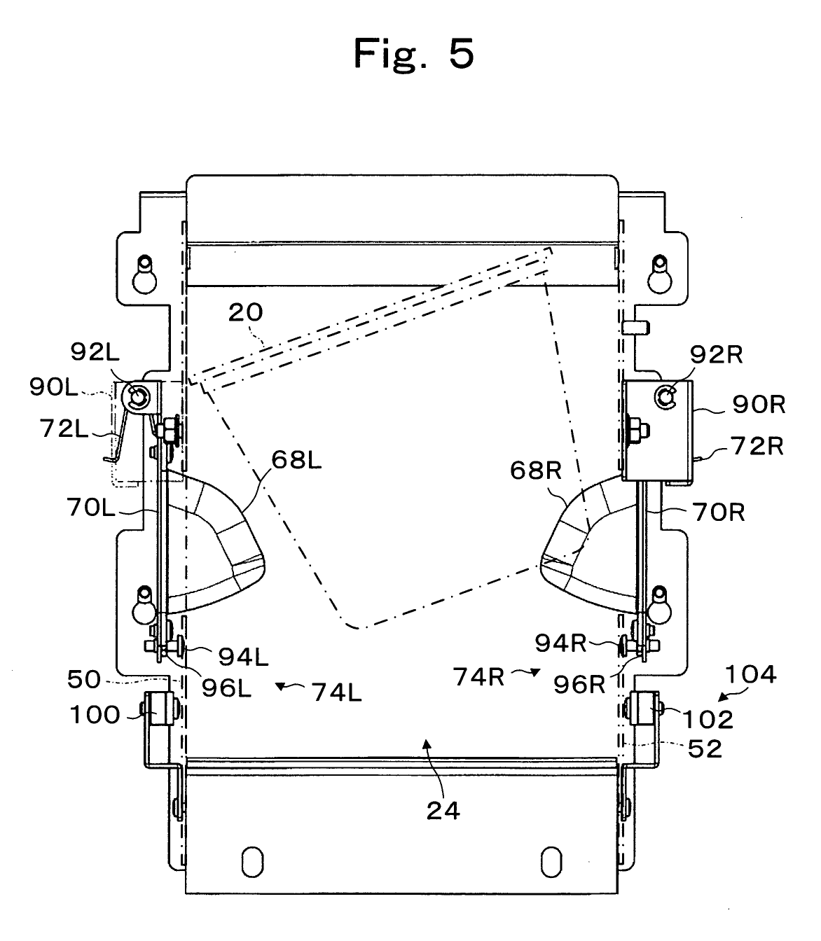

Therefore base 70L is usually urged in the counter clockwise direction by urging unit 72L shown in FIG. 5. The end of adjusting screw 94L is stopped by left side wall 50, and is positioned at the standby position (the solid line position as shown in FIG. 5). In this situation, projecting section 86L is located almost at left holding opening 60. Therefore a finger of a little child can not be inserted to the space between projecting section 86L and left holding opening 60, because it is narrower than the finger. The standby position of holder 68L can be changed by adjusting screw 94L. The standby position of the left and right holders 68L, 68R are adjusted by moving in approximately one mm, when the bottom 20B has made contact with upper bottom 56U. In other words, container 20 is supported by holders 68L, 68R just before being supporting on upper bottom 56U. Therefore the holders 68L, 68R move resiliently and also the falling speed is reduced. As a result, the shock upon the container 20 falling on upper bottom 56U is defused and diminished.

Opening 96 is rectangle and is located over right holding unit 66 at right side wall 52. Tokens chute 98 is inserted into the opening 96. Dispensed tokens which are dispensed by tokens dispensing unit 18 arrive into the chute 98. Afterwards the tokens slide down on the chute 98, and go into the container 20 which is located at dispensing section 24. However the tokens can be dispensed directly into container 20. Emitting element 100 is attached at the lower section at left side wall 50, and receiving element 102 is attached at right side wall 52. The container detecting unit 104 is structured by the emitting element 100 and receiving element 102 for detecting container 20 at dispensing section 24. When the detecting unit 104 is located at the lower section of dispensing section 24, an abnormal situation can be detected; for example the container 20 slants, and the bottom 20B does not have contact with upper bottom 56U.

The container detecting unit 104 can be changed to another unit which has the same function; for example either a photo-electrical type, a mechanical type or sonic type. The counter 106 has a function which detects the token's amount in container 20 at the dispensing section 24.

In this embodiment, counter 106 provides an indirect detection where tokens which are dispensed one by one to via tokens chute 98 by token dispensing unit 18 are detected optically and are counted by a counter (on software in controlling unit 30). When the token dispensing unit 18 has a sensor which detects the dispensed token, the counting is executed based on the detecting signal from the sensor. Display unit 26 has a function which displays some message to the customer, and can use either a liquid crystal display, a cathode-ray tube, an electric fluorescent tube or a plasma display panel. Operating board 28 has a gain function which starts some operation, when a customer changes money to tokens. For example, it is the money deciding button 108 which decides to change the received money in banknote form and distinguishing receiving unit 14 and coin distinguishing receiving unit 16. Therefore the money deciding button 108 is located corresponding to purchaseable money. For example, the buttons correspond to 1000 Yen, 2000 Yen, 3000 Yen and 5000 yen or similar dollar or other currency value, however operating board 28 can be changed to a key board or a touch-sensitive panel.

Controlling unit 30 receives signals from banknote distinguishing receiving unit 14, coin distinguishing receiving unit 16, operating board 28, container detecting unit 104 and counter 106, and executes a predetermined process, also it directs token dispensing unit 18, container providing unit 22 and display 26. The controlling unit is a microprocessor.

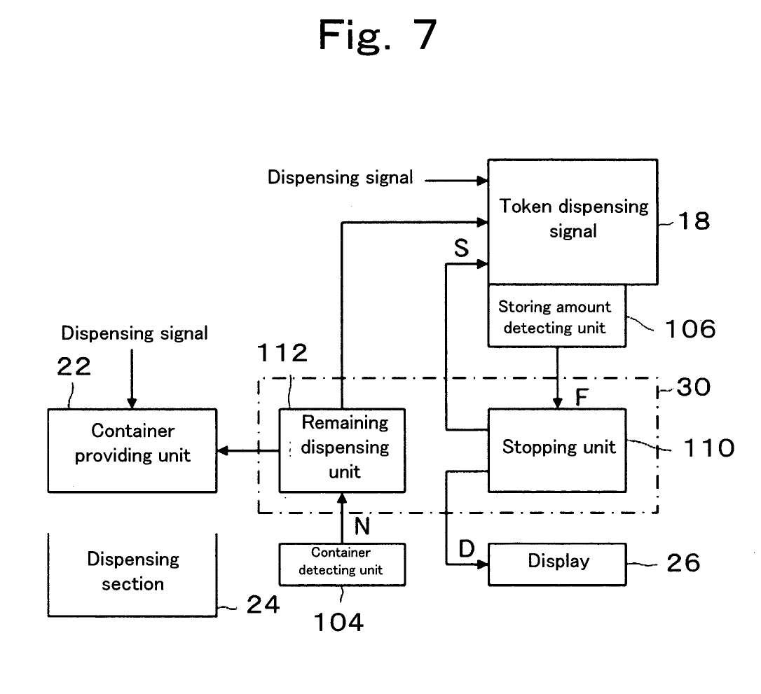

The controlling unit 30 is explained referring to a block diagram in FIG. 7. Controlling unit 30 includes at least the stopping unit 110 and dispensing directing unit 112. The stopping unit 110 is a software in this embodiment. The stopping unit 110 receives a counting signal from counter 106. When the counter 106 counts a predetermined amount, the stopping unit 110 outputs a dispensing stopping signal S to the token dispensing unit 18. When token dispensing unit 18 receives dispensing stopping signal S, the dispensing tokens are stopped. Also, the stopping unit 110 outputs removing signal D. Displaying unit 26 displays an indication which is removing the container 20 which is full.

When the dispensing indicating unit 112 receives a nothing signal N for the container at the dispensing section 24 from the container detecting unit 104, the container providing unit 22 is operated. In other words, only one container 20 is provided to the dispensing section 24. Next, the token dispensing unit 18 is started, also a predetermined token is dispensed into the container 24.

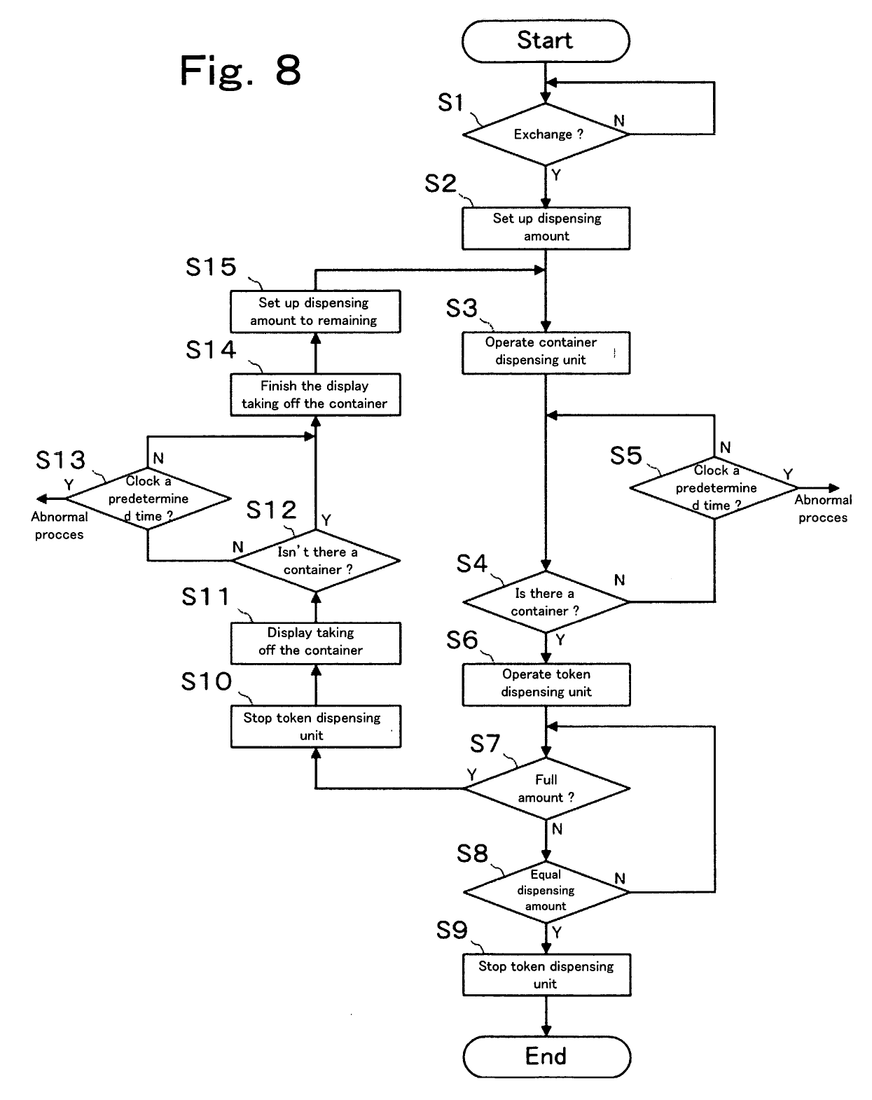

Next, the operation of the present invention is explained referring to a flow chart in FIG. 8. Before the operation, a dispensing amount of token corresponding to the received money is set up. For example, 100 tokens for 1000 Yen, 200 tokens for 2000 Yen, 350 tokens for 3000 Yen and 800 tokens for 5000 Yen. Also the full amount of container 20 is set up at 300 tokens.

Before changing to tokens, the banknote distinguishing receiving unit 14 and/or the coin distinguishing receiving unit 16 receives money, also the received money is displayed on the displaying unit 26. A customer pushes a money deciding button 108. When the received money is larger than the purchasing money, the difference is dispensed to a changing slot (not shown).

When money deciding button 108 is pushed, the changing signal is distinguished in step S1, and the program goes to step S2. In step S2, when the money deciding button 108 is 1000 Yen, the dispensing amount is set to 100 tokens.

Next, in step S3, container providing unit 22 is operated, also the lowest container 20 at container storing section 36 is provided to dispensing section 24. In other words, only the lowest container 20 falls down by separating section 38. The falling speed of the fallen container 20 is reduced by holders 68L and 68R, and the fallen container 20 is guided to a predetermined position. In other words, plural cams 46 are rotated by motor 39 through gears 42.

Therefore the upper surface of the flange of lowest container 20 is pushed downwards by the cam surface which located at the peripheral, and the container 20 falls down. When the container 20 falls, the situation not the same. In other words, the slant and/or the position differ. For example, when container 20 falls at the middle between holders 68L and 68R and in perpendicular, the side wall 20S has contact with holding surfaces 80L and 80R, immediately after the bottom 20B is supported by bottom 56U.

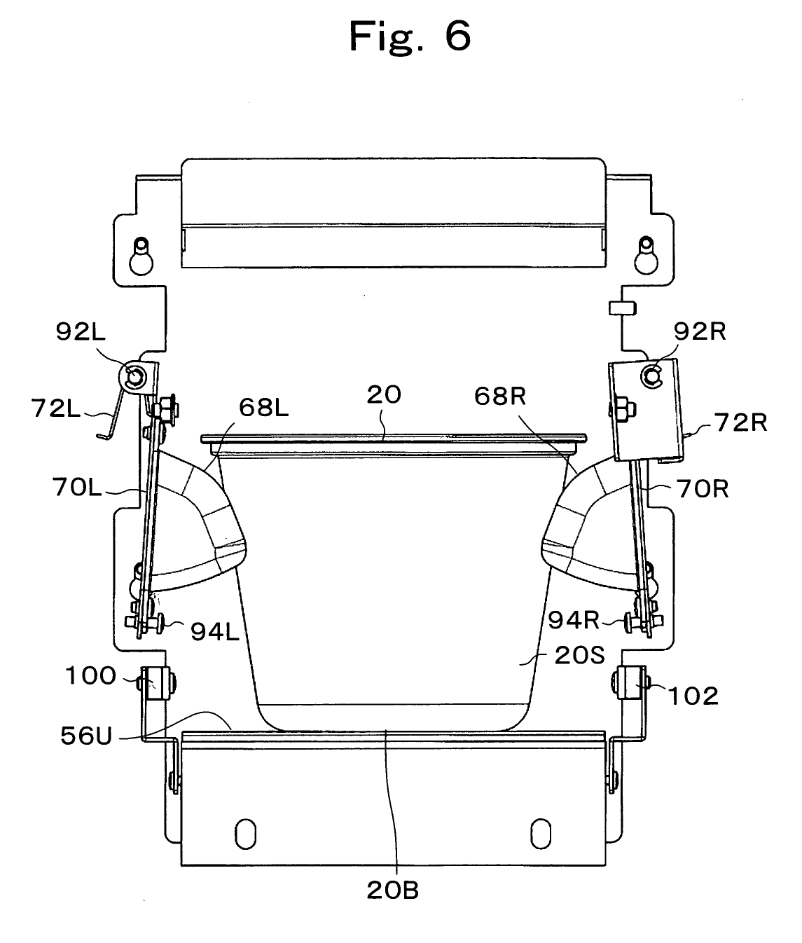

Holders 68L, 68R are pushed from the position in FIG. 5 to the position in FIG. 6 by side wall 20S. In other words, base 70L is pivoted in the counter clockwise direction opposite the urging force by urging unit 72R shown in FIG. 5. Base 70R is pivoted in the counter clockwise direction opposite the urging force by urging unit 72R. Therefore side wall 20S of container 20 falls opposite the urging forces of urging units 72L, 72R and slides of the holding surfaces 80L, 80R with friction. As a result, the falling speed is reduced drastically. The shock of container 20 is small and the jump is short, when the bottom 20B runs into bottom 56U. Also container 20 is held by holders 68L and 68R. Therefore when container 20 has momentum to jump, the container 20 can not jump, because the container 20 is kept by friction. As a result, the container 20 is located continually at the fell position. Also, when the container 20 is off to the side of front opening 46 as the dotted line shown in FIG. 4, the side wall 20S at the side of the opening 46 has contact with guiding surfaces 82L, 82R of the side of opening 46 faster than or at the same time as the reforming sections 78L, 78R. Accordingly, the container 20 falls down and is guided by rear side wall 54.

In other words, the position of container 20 falls on bottom 56U which is located at approximately the middle section where the container 20 is held by holding surfaces 80L, 80R. In this falling process, the holders 80L, 80R are pushed by container 20 in the left and right directions in the same way as mentioned above. Therefore the falling speed is reduced mentioned above. As a result, container 20 does not jump and is kept at a predetermined position.

When the falling position is off to the side of taking slot 46, container 20 is pushed towards rear side wall 54 by the concave surface of holding surfaces 80L, 80R. Accordingly, the container 20 moves to a position where the container 20 receives equal force from holding surfaces 80L, 80R.

When the fell position of container 20 is off the side of rear side wall 54, the container 20 is pushed opposite the above-mentioned, and the container 20 does not jump and is kept at a predetermined position. When container 20 slants and falls as the dotted line shown in FIG. 4, the side wall 20S has contact with reforming sections 78L, 78R. The container 20 pivots at the contacting point which is located between reforming sections 78L and 78R. Also, the container 20 is pushed to the side of rear wall 54 and falls, and sits down on bottom 56U. Accordingly, container 20 does not jump substantially, and is kept at a predetermined position.

When container 20 slants and falls opposite the above-mentioned direction, the container is guided in the opposite direction. Accordingly, container 20 does not jump substantially, and is kept at a predetermined position.

When container 20 slants in the left and falls as the dotted line as shown in FIG. 5, the bottom 20B and side wall 20S have contact with guiding surface 82R and is guided in the opposite direction of the side of holder 68L.

Also, side wall 20S is pushed towards the side of holder 68L by guiding surface 82R, and the position of the front and the rear is kept at a predetermined position, and falls down.

In this process, the side wall 20S of container 20 is guided by holding surface 80L of holder 68L, and the container 20 sits down on bottom 56U. At the same time, container 20 pushes holders 68L and 68R to the outside. Accordingly, the falling speed is reduced. As a result, container 20 does not jump substantially and is kept at a predetermined position.

When container 20 slants and falls opposite the above-mentioned, the container is guided in the opposite direction and does not jump and is kept at a predetermined position. When container 20 slants in the front and the rear and falls, the container 20 does not jump and is kept at a predetermined position by the guiding function and the buffering function which are the above-mentioned in the front and the rear and in the left and the right holders 68L, 68R.

Next, the program goes to step S4, and distinguishes an existing signal of container 20 from container detecting unit 104. When there isn't an existing signal, the program goes to step S5, afterwards the program clocks at a predetermined time from the operation of container providing unit 22. In step S5, when the predetermined time is clocked, an error indication is displayed at display 26 and all processes are stopped and goes to the standby situation.

When there is container 20 in step S4, the program goes to step 6 and starts token dispensing unit 18. Therefore token dispensing unit 18 dispenses tokens one by one to token chute 98.

The tokens in chute 98 slid in token chute 98 and fall into container 20. At the same time, the dispensed tokens are counted, and the storing amount of the tokens is detected indirectly.

In step S7, the counted amount is compared to the full amount which is 300. When tokens equal 100, the program goes to step S8, because the counted amount is smaller than 300. In step S8, the counted amount is compared to 100 which was set up in step S2. When the counted amount is smaller than the set up amount, the program returns to step S7, and the dispensing operation continues. In step S8, when the counted amount corresponds to 100, the program goes to step S9, and stops token dispensing unit 18, and the dispensing operation finishes. At the same time corresponding to the stopping of token dispensing unit 18, displaying the finished indication is desirable.

Next, in the case where money deciding button 108 corresponding to 3000 yen is pushed is explained. As the same above-mentioned, the dispensing tokens amount is set to 350 in step S2. Therefore when the counted amount of counter 106 corresponds 300, stopping unit 110 outputs dispensing stopping signal S and removing signal D, afterwards the program goes from step S7 to step S10. In step S10, token dispensing unit 18 is stopped based on the dispensing stopping unit S, and the dispensing of tokens is stopped.

In step SI 1, the indication of taking off container 20 from dispensing section 24 is displayed on the display 26 based on the removing signal D. The indication of taking off container 20 can be changed to either a voice or combining a voice. Also, the container 20 can be automatically taken off by a automatic taking off unit.

Next, in step S12, the existence of container 20 at dispensing section 24 is distinguished based on a signal of container detecting unit 104. In other words, taking off of container 20 is distinguished based on non-signal N of container detecting unit 104. In step S12, when there is container 20, the program goes to step S13, and it clocks at a predetermined time.

In step S13, the predetermined time is clocked, the error is distinguished, and an error indication is displayed on displaying unit 26 and executes the error process as above-mentioned. In step S12, when there is no container 20, the program goes to step S14 based on the nothing signal N, also the indication which urges the taking off of container 20 is stopped.

Next in step S15, the value 300 is subtracted which is dispensed from 350 which is the set up dispensing amount, afterwards a new dispensing amount is set up at 50. Next, the program returns to step S3, also container providing unit 22 is operated, and a new container 20 is provided to dispensing section 24. In this process, when container 20 is slanting and/or displacement, it is guided to a predetermined position as the same above-mentioned by holders 68L, 68R. Afterwards container 20 is distinguished in step S4, also token dispensing unit 18 operates, and it dispenses 50 tokens. In step S8, when 50 tokens are dispensed, the program goes to step S9, and token dispensing unit 18 is stopped. Then the token dispensing process finishes.

When money deciding button 108 of 5000 Yen is pushed, the dispensing amount is set to 800. Accordingly, the process from step S10 to S15 is executed twice. In other words, when the dispensed tokens amount becomes 300, the process from step S10 to S15 is executed once. In step S15 in second, the dispensing amount is set to 200. In step S8, when the counted amount becomes 200, the program goes to step S9, and token dispensing unit 18 is stopped. Then the token dispensing process finishes.

In this embodiment, step S9 and S10 which stop the token dispensing unit 18 is accomplished with the stopping unit 110. Also, step S3 is the dispensing directing unit 112. The stopping unit 110 and the dispensing directing unit 112 can be changed to a logic circuit.

When counter 106 is the token counter of token dispensing unit 18, the full amount of container 20 can be set in detail as with the above-mentioned embodiment. Therefore the number of times of the taking off operation does not become too large. Also, the dispensed tokens amount are the same every time.

With the present invention, the falling speed of the container 20 is reduced by a pair of holders and is guided to a predetermined position and is kept by the holders every time. Therefore the dispensing tokens are received into the container. Also, the container is guided to a predetermined position when the container slants. The holders are made up with surfaces that are continuous at the inner facing sides, bottom, forward edge and back edge and at the top. Therefore, a customer is not injured by the holders.

While a specific embodiment of the invention has been shown and described in illustrate the application of the principles of the invention, it will be understood that the invention may be embodied otherwise without departing from such principles.

What is claimed is:

1. A token dispensing apparatus comprising;
a dispensing section;
a container providing unit providing a container to the dispensing section one by one based on a dispensing signal, the container having a bucket form in shape for holding tokens;
a token dispensing unit for dispensing the tokens to the provided container at the dispensing section;
a pair of holders which are located extending towards each other and extending across a portion of the dispensing section, the holders include holding surfaces, each with arcuate portions for contacting the container.

2. The token dispensing apparatus claimed in claim 1, wherein the holders include reforming sections which are located at the ends of the holding surfaces, and guiding surfaces which are extended outwards and upwards from the reforming sections and the holding surface.

3. The token dispensing apparatus claimed in claim 2, wherein the dispensing section is a box and includes a taking out opening located at a side wall and three side walls, holder openings located at the side walls which continues to a taking out opening, and the holders protrude from the openings.

4. The token dispensing apparatus claimed in claim 1, further comprising:
a container detecting unit detecting the container at the dispensing section;
a dispensing controlling unit starting the token dispensing unit based on a container detecting signal from the detecting unit,
a counting unit counting the dispensing tokens from the dispensing unit;
a stopping unit outputting a stopping signal for the dispensing unit when the counter counts at a predetermined number.

5. A disc dispensing apparatus comprising;
structure defining a dispensing section;
container feed means for storing a plurality of containers and providing bucket shaped containers to a dispensing section one by one based on a dispensing signal;
a token dispensing unit for dispensing the tokens to the provided container at the dispensing section;
a pair of holders which are located extending towards each other and extending across a portion of the dispensing section, the holders include holding surfaces, each with arcuate portions for contacting the container.

6. The disc dispensing apparatus claimed in claim 5, wherein each of the holders include container directed edge surface sections located at the ends of the holding surfaces, and guiding surfaces which extending outwardly and upwardly from the edge surface sections and from the holding surface as a continuous surface.

7. The disc dispensing apparatus claimed in claim 6, wherein the structure defining the dispensing section is a box and includes a taking out opening located at a side wall and three side walls, holder openings located at the side walls which continues to a taking out opening, and the holders protrude from the openings.

8. The disc dispensing apparatus claimed in claim 1, further comprising:
a container detecting unit detecting the container at the dispensing section;
a dispensing controlling unit starting the token dispensing unit based on a container detecting signal from the detecting unit,
a counting unit counting the dispensing tokens from the dispensing unit;
a stopping unit outputing a stopping signal for the dispensing unit when the counter counts at a predetermined number.
